(19) United States
(12) Patent Application Publication
(10) Pub. No.: US 2011/0106781 A1
(43) Pub. Date: May 5, 2011

(54) System and Method for Dating Using Vehicle License Plate Numbers

(76) Inventor: Sharanne Pearson, Chicago, IL (US)

(21) Appl. No.: 12/608,222

(22) Filed: Oct. 29, 2009

(51) Int. Cl. G06F 17/30; H04W 4/12

(52) U.S. Cl. 707/706; 455/466; 707/E17.108; 707/769; 711/112

(57) ABSTRACT

A web-assisted service where a license plate number or partial license plate number may be used to determine if the person in a vehicle is willing to engage in further communication and possible contact. When a member of the service sights and interesting person in a vehicle, they can enter the license plate number (or partial plate number if the entire number is not visible or other vehicle information) into a webpage that can be accessed via cellular telephone or any computer on the internet. If the person in the vehicle is a member, various profile information can be presented including a photograph, interests, what that person wants (dating, marriage, etc.), and a safe way to send a message to that person can be made available, namely communication through the service to the person. This can all be done without revealing the name or actual identity of either person for safety.

### BACKGROUND

1. Field of the Invention

The present invention relates generally to online dating systems and more particularly to a system and method for dating using vehicle license plate numbers to find interesting people.

2. Description of the Prior Art

There are numerous dating and social networking systems, services and webpages online that allow people to search for others for dating, marriage, correspondence or simply friendship. These prior art services however, require a person to first log onto a particular site, and then run a search. Many times, the results of such searches turn up “hits” that are not geographically close enough for the searcher to realistically meet the other person. Also, prior art systems do not allow actual visual contact with the person searched.

Many times, people spot other interesting people that they might like to meet for friendship or dating in traffic. For example, a man might be stopped in traffic at a stop light next to a lady in a different vehicle. There is no way for the man to know if perhaps that woman is single and might be interested in meeting. Sometimes people wave, signal or otherwise indicate interest; however, this can be inconvenient and possibly misunderstood by the other person. What is badly needed is a way that a person who spots another person of possible interest in a vehicle can check to see if that person is willing to be contacted, and then possibly contact them under the safety of a web service.

### SUMMARY OF THE INVENTION

The present invention relates to a web-assisted service where a license plate number or partial license plate number, as well as other vehicle characteristics, may be used to determine if the person in a vehicle is willing to engage in further communication and possible contact. When a member of the service sights an interesting person in a vehicle, they can enter the license plate number (or partial plate number if the entire number is not visible) into a webpage that can be accessed via cellular telephone or any computer on the internet. They can also enter other information about the vehicle such as color or make/model. A database keyed by license plate numbers and vehicle information can be accessed by a server computer to see if the person in the vehicle is a member. If the person in the vehicle is a member, various profile information can be presented to the searcher including photographs, interests, what that person wants (dating, marriage, etc.), and a safe way to send a message to that person can be made available, namely communication through the service to the person. This can all be done without revealing the name or actual identity of either person for safety.

The advantage of this type of searching is that the searcher has already seen the person and knows that they are at least somewhat interested. This is superior to simply seeing a 2-dimensional photograph online, since most people do not really resemble their photographs, and many people lie about their age or weight on typical internet dating sites.

### DESCRIPTION OF THE FIGURES

Attention is now directed to several illustrations that aid in understanding the features of the present invention.

FIG. 1 shows a schematic diagram of an embodiment of the system of the present invention.

FIG. 2 shows a webpage for license plate entry.

FIG. 3 shows a returned profile webpage.

FIG. 4 shows a sign-up webpage.

FIG. 5 shows a return list on a partial license plate search.

Several drawings have been presented to better illustrate the present invention. The scope of the present invention is not limited to what is shown in the Figures.

### DESCRIPTION OF THE INVENTION

The present invention relates to a system and method where an interested person who is a member of the service can enter a license plate number, partial license plate number, and optionally color and make/model of a vehicle (or other vehicle details) to see if the driver or owner is also a member of the service. If so, the interested person can see a profile of the driver or owner and can send a safe, secure message. The driver or owner, if interested, can see the sender's profile as well as message, and respond or not respond as desired.

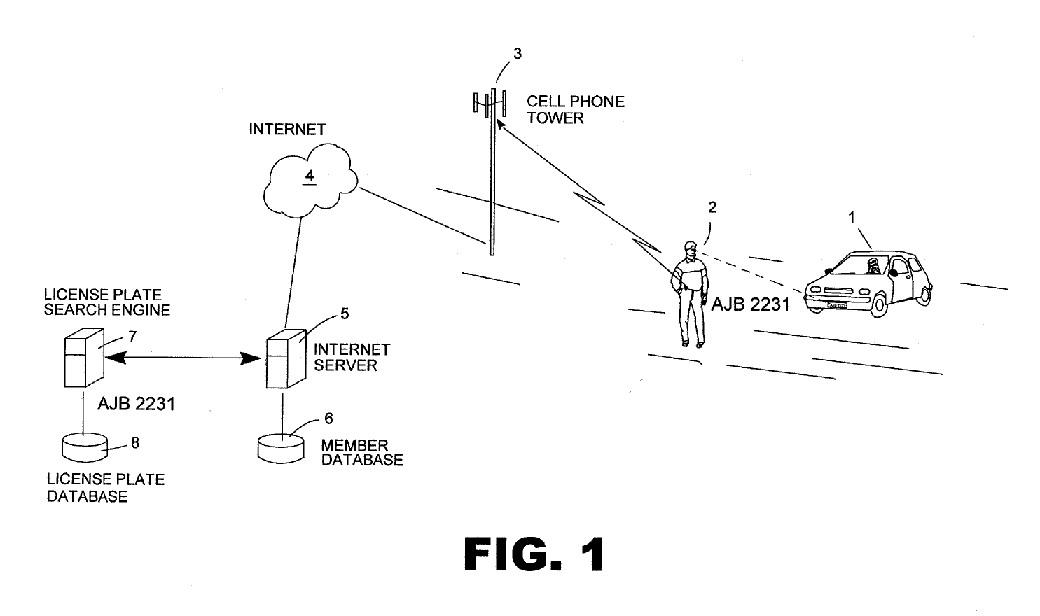

Turning to FIG. 1, a schematic diagram of an embodiment of the present invention can be seen. A first person 2, either on foot or in a vehicle, spots a vehicle 1 with an interesting driver. The first person may be a single that desires dating. In FIG. 1, a man on foot 2 spots an interesting lady in a vehicle 1. He also sees that the vehicle license number is AJB 2231. He may optionally note the state of the license plate and the color/make/model of the vehicle. If the vehicle is moving, he may only be able to get part of the license number.

Assuming that the interested person 2 is a member of the service of the present invention, he can enter the full or partial license plate number into a search page on a website. In the case of FIG. 1, the man 2, who is a member, enters the plate number into his cellphone (which is browsing the website of the service). The radio signal from the cellphone travels to a near-by cellphone tower 3 and from there into the internet 4 through numerous routers and servers until it reaches a computer server 5 that hosts the website. The server 5 is a computer that contains a processor and memory and accesses a hard disk 6 located somewhere on the internet 4 that contains a member database. The man's identity is checked (via a sign-on) and then he is allowed to perform a search with the license plate number. The search may take place on the same computer server, or it may be on a remote license plate server 7 that contains a license plate (or other vehicle detail) search engine that searches a license plate database 8 that is also stored on a hard disk or other memory device.

If the searched license plate number belongs to another member of the service, the license plate server 7 signals over the network to the website hosting server 5 that the number has been found. The internet server 5 can then provide a profile of the searched member from the member database 6. It should be noted that the license plate server 7 and the internet server 5 can be the same computer. Also, the license plate database 8 can be stored on the same hard disk as the member database 6 or can be part of the member database 6.

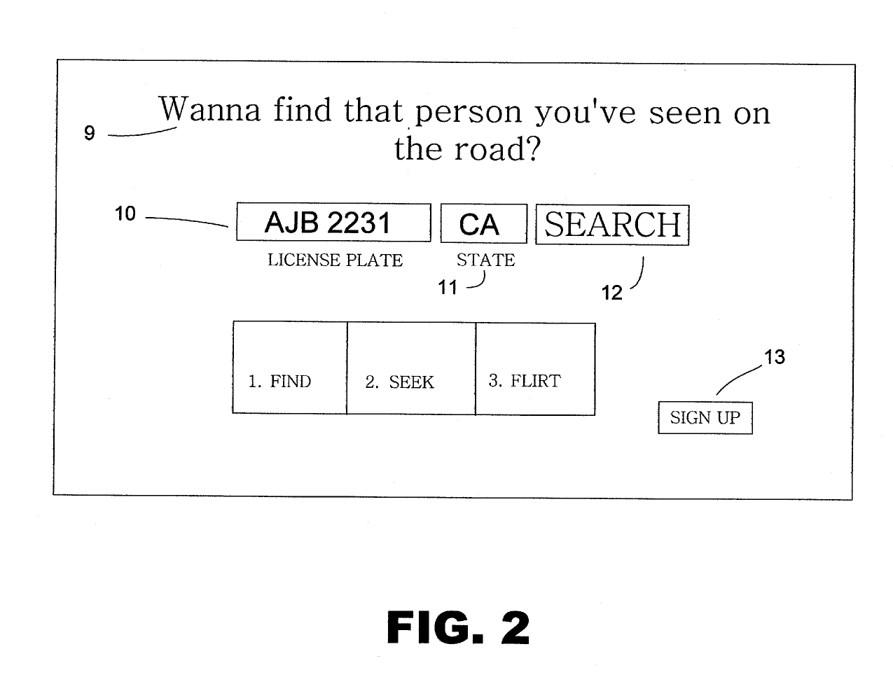

FIG. 2 shows an embodiment of a license plate search page. A title 9 announces the function of the webpage. A search can be made by entering the license number 11, optionally the state of the license plate 11 and then pushing the search button 12. An instruction box can also direct the searcher to 1) Find, 2) Seek and 3) Flirt with the other person. This type of box can simply bring up other webpages or give instructions on how to use the site. If the interested person is not a member of the service, a sign-up button 13 can get them to sign up.

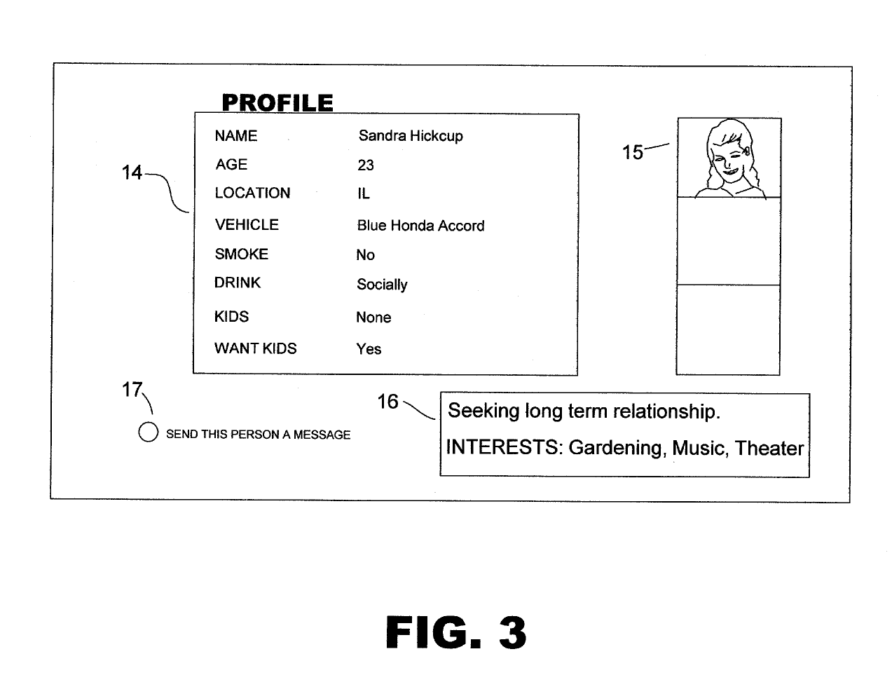

FIG. 3 shows a profile that can be returned by the internet server 5 over the internet 4 to the searcher 2 either by hard connection or by cellphone as shown in FIG. 1. This page can contain a profile box 14 giving all of the information about the member as well as that person's interests 16 and one or more photos 15. If the searching member wishes to send the searched person a message, a button 17 can direct them to a message composition page (not shown). This message is sent electronically over the internet or other network to the registered member. It can be done through webpages or by Email or by any other method of sending a message.

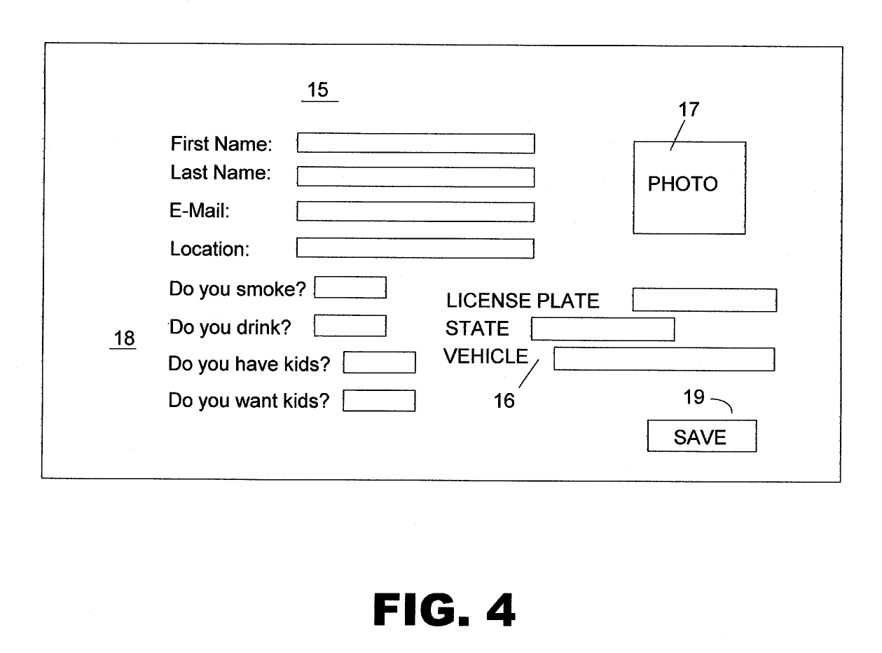

When a new member is signed up, a page such as that shown in FIG. 4 can be used. Here, the prospective member provides personal information 15 that may remain confidential as well as information 18 that may be transferred to other interested members, an optional photo 17, and vehicle information 16. A save button 19, can save the new member's profile. Generally, a new member must provide a name, address, age, gender and Email address. Other information may be optionally requested. If the new member is willing to allow searching on their vehicle, their license plate number, color, make, model and other vehicle details can be entered.

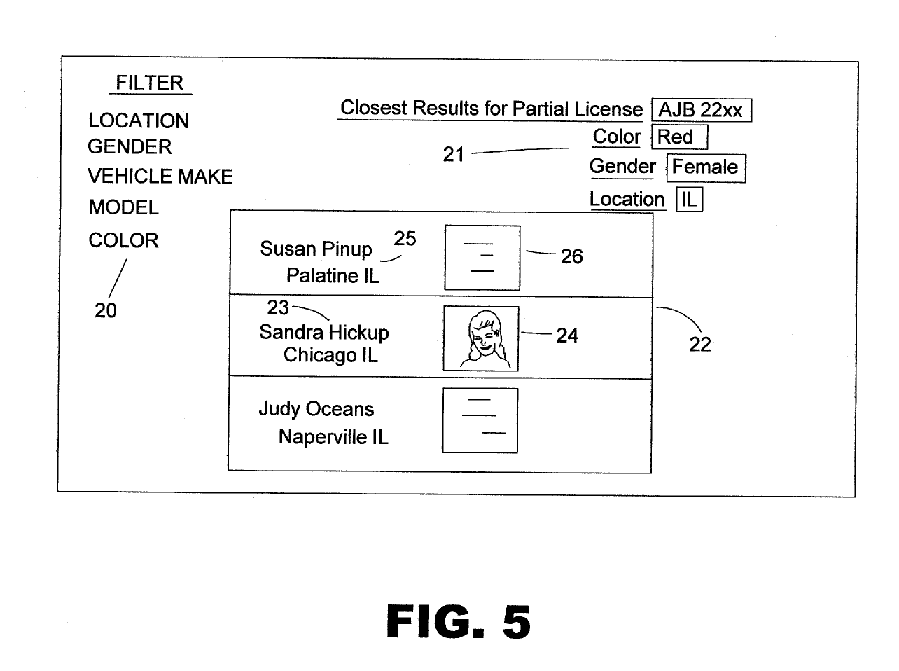

In the case of a search on a partial license plate number, several partial closest matches may be returned to the searcher as shown in FIG. 5. Here a filter 20 allows searches on different items 20 such as location, gender, vehicle make, model, color, etc. The closest results for the partial information 21 can be returned on a particular part 22 of a webpage. Here, the partial information 21 was a red car with a female member and an Illinois plate that started with the characters AJB 22. The rest of the plate number was unknown. The system returned several wrong results 25, 26 and a correct result 23, with photo 24 for the license AJB 2231 of FIG. 1. Search engines that use logical techniques to perform partial searches can be used to perform this function. These search engines can run on a search engine server or computer 7 (FIG. 1). The logical techniques can include partial matches, fuzzy matches and statistical matches as well as other known searching techniques. The search engine server 7 contains a processor, memory, communications port and other hardware necessary to access a license plate database 8. Other partial data such as approximate height and weight, color of hair, eyes of the person or any other known data can be entered into various embodiments of the present invention. The scope of the present invention includes any and all partial information about the person of interest.

For example, the man 2 in FIG. 1 may realize that the lady in the vehicle 1 is slender and blond. He may also be aware that the vehicle is red and is a Honda Civic. He may not know the year; however, he knows that it is not too old. He may enter all of this information is free-form style in some embodiments of the present invention. The search engine server 7 can then run logical algorithms attempting to search the license plate database 8 or member database 6 to find a possible match. The various servers and computers in the system communicate over the internet using various network techniques including cable, landline telephone, WiFi, Bluetooth, cellular telephone, both GSM and CDMA, or 3G UMTS or CDMA2000 with all variations as well as internet protocols such as TCP/IP or UMTS. All servers and computers of the present invention communicate electrically which each other and over the various networks.

It should be understood that the present invention is not just limited to singles seeking singles, or men seeking ladies; it can be used by anyone seeking anyone using a license plate number and other partial information to determine if someone is a member of the service and is interested in further communication. Every license plate on a driven vehicle is visible to all. The present invention simply uses the license plate number as one of several possible search criteria. There is no connection with any government entity since the license plate numbers are stored in a database within the service. It should also be understood that one does not need to have a license plate number to be a member. Some members prefer to search only and not be themselves searchable. Also, not everyone owns or has access to a motor vehicle. Generally, an Email address can also suffice as an identifier.

Several descriptions and illustrations have been presented to aid in understanding the present invention. A person of skill in the art will realize that numerous changes and variations can be made without departing from the spirit of the invention. All such changes and variations are within the scope of the present invention.

I claim:

1. A web-based service comprising:
at least one server communicating over a network to receive at least a partial vehicle license plate number, wherein said server communicates electrically with a search engine program running on a processor passing said at least partial vehicle license plate number to said search engine;
wherein said search engine electrically accesses a database stored on at least one hard disk, said search engine returning a match or partial match if a member of said web-based service has a license plate number in said license plate database;
wherein said search engine returns a profile of said member from a member database, said member database also stored on a hard disk;
said service allowing a personal message to be sent electronically over a network to said member.

2. The web-based service of claim 1 wherein said search engine runs on said server.

3. The web-based service of claim 1 wherein further information about a vehicle can be provided to said search engine including make, model or color.

4. The web-based service of claim 1 wherein further information about said member can be provided to said search engine including approximate height, approximate weight or hair color.

5. The web-based service of claim 1 wherein said server returns profiles of closest-match members when only partial information is supplied to said search engine.

6. The web-based service of claim 1 wherein said processor accesses a memory to run a logical match program when only partial information is supplied to said search engine.

7. A service running on a web server comprising:
a search engine running on a processor that can communicate over the internet which can be provided information about a license plate via the internet from a first member of said service through a server; and,
wherein said search engine returns profile information about a second member of said service over the internet to said first member from said server;
wherein said server contains memory, and accesses at least one database stored on a hard disk, said database containing profiles and license plate numbers of members of the service.

8. The service of claim 7 wherein said search engine can be provided partial information about said license plate.

9. The service of claim 7 where in said search engine runs logical search programs stored in said memory.

10. The service of claim 7 wherein said first member can contact said server from a cellular telephone.

11. The service of claim 8 wherein profiles of several members stored in said database are returned in response to said partial information.

12. An internet-based social service comprising a database of members stored on a hard disk and keyed by license plate numbers, wherein a first member can enter a license plate number into a cellphone or other computer and transmit said license plate number over a network to a server in electrical communication with said hard disk, and wherein said server can determine if said database contains a profile for a second member with that license plate number, and if said profile is found, can return said profile over the network to said cellphone or other computer.

13. The internet-based social service of claim 12 wherein said first member can enter a partial license plate number.

14. The internet-based social service of claim 13 wherein profiles of more than one member of said service are returned in response to said partial license plate number.

15. The internet-based social service of claim 12 wherein said server accesses a search engine running on a processor.

16. The internet-based social service of claim 15 wherein said search engine executes a logical program adapted to searching on partial data, said logical program being stored in a memory device.

17. The internet-based social service of claim 12 wherein said first member can send a message to said second member.

18. The internet-based social service of claim 17 wherein said message is sent over a network.

19. The internet-based social service of claim 18 wherein said network is a cellular telephone network.
